(19) United States
(12) Patent Application Publication
(10) Pub. No.: US 2003/0161910 A1
(43) Pub. Date: Aug. 28, 2003

(54) Process for producing fermented foods rich in gamma-aminobutyric acid and free amino acids

(76) Inventors: Hideyuki Aoki, Hiroshima (JP); Ichiyo Uda, Hiroshima (JP); Noriko Miyamoto, Hiroshima (JP); Keiko Tagami, Hiroshima (JP); Yuji Furuya, Hiroshima (JP); Mitsumasa Mankura, Hiroshima (JP)

Correspondence Address: BRUCE LONDA, NORRIS, MCLAUGHLIN & MARCUS, P.A., 220 EAST 42ND STREET, 30TH FLOOR, NEW YORK, NY, 10017, US

(21) Appl. No.: 10/296,401

(22) PCT Filed: Jun. 1, 2001
(86) PCT No.: PCT/JP01/04640

(30) Foreign Application Priority Data
Jun. 2, 2000 (JP) 2000-165351
Sep. 26, 2000 (JP) 2000-292622

(51) Int. Cl. A23K 1/00

(52) U.S. Cl. 426/49

(57) ABSTRACT

Fermented soybean foods rich in γ-aminobutyric acid are produced by fermentation of soybean using Tempe molds.

Fermented soybean foods rich in γ-aminobutyric acid and free amino acids are produced by fermentation of soybean using Tempe molds with anaerobic treatment.

Fermented cereal foods rich in γ-aminobutyric acid and free amino acids are also produced by fermentation of cereals with anaerobic treatment.

Rhizopus oligosporus and Rhizopus oryzae are favorably used as the Tempe mold and Koji molds.

### TECHNICAL FIELD

In a first aspect, the present invention relates to a process for producing fermented soybean foods rich in γ-aminobutyric acid. In particular, the present invention relates to a process for producing fermented soybean foods rich in γ-aminobutyric acid by fermentation of soybean using Tempe molds belonging to the genus Rhizopus while utilizing effective ingredients such as proteins, amino acids and antioxidant originating from soybean and the fermented soybean products.

In a second aspect, the present invention relates to fermented soybean foods rich in γ-aminobutyric acid and other free amino acids and a production process thereof. In particular, the present invention relates to fermented cereal soybean foods rich in γ-aminobutyric acid and free amino acids and a process for producing thereof, wherein soybean is fermented using Tempe molds belonging to the genus Rhizopus with an anaerobic treatment, thereby producing the fermented soybean foods rich in γ-aminobutyric acid having various physiological functions and tasting free amino acids while containing effective ingredients originating from soybean and fermented soybean products such as proteins, peptides, antioxidant, vitamins, minerals, isoflavone and angiotensin conversion enzyme inhibitors in addition to a elevation of systolic blood pressure.

In a third aspect, the present invention relates to a process for producing fermented cereal foods rich in γ-aminobutyric acid and free amino acids. In particular, the present invention relates to a method for producing fermented cereal foods by fermentation using Koji molds with an anaerobic treatment, thereby producing the fermented cereal products rich in free amino acids such as γ-aminobutyric acid, valine, isoleucine and lysine having various physiological functions and taste while containing vitamins, anthocyanin, sesamin, isoflavone, soybean saponin, phytic acid, dietary fibers, minerals and antioxidant originating from the cereals, as well as effective ingredients originating from fermented cereals such as digested proteins, peptides and antioxidant.

### BACKGROUND ART

While amino acids as basic constituents of proteins mainly serve as starting materials for biosynthesis of proteins and hormones in the living body, individual amino acids have been known to play a quite important role in tastes by manifesting sweetness and taste. In addition, each amino acid has its own pharmacological action, for example reinforcement of muscle and liver functions by valine and isoleucine, and appetite increasing action and promotion effect on calcium absorption by lysine.

γ-Aminobutyric acid is an amino acid that has been particularly noticed in recent years for its elevation of systolic blood pressure in addition to other effects as described below, and is widely used as a health food material for preventing hypertension:

(1) elevation of systolic blood pressure;

(2) neutral lipid decreasing action and obesity preventive effect;

(3) ataractic action and alleviation of climacteric disturbance;

(4) hypnotic action; and

(5) alcohol and aldehyde metabolizing action and deodorant action.

Recently, various physiologically active substances effective for preventing life style related diseases such as arterial sclerosis have been found in cereals such as soybean, sesame and rice. Meanwhile Miso (soybean paste), Natto (fermented soybean) and tofu (soybean curd) are traditional daily foodstuffs, effects for preventing the life style related diseases such as osteoporosis, myocardial infraction and arterial sclerosis have been found in proteins, isoflavone and vitamins contained in the soybean. Therefore, the foodstuffs using the soybean are being highlighted as functional foodstuffs.

Amino acids such as γ-aminobutyric acid are noticed as materials for food supplements due to their various pharmacological actions. Since the cereal materials rich in these amino acids are expected as health food materials and functional seasoning materials, since they posses cereal's own functions and pharmacological functions of various amino acids such as γ-aminobutyric acid having elevation of systolic blood pressure, and taste improving ability of the amino acids.

The following methods have been studied with respect to the method for increasing the content of the free amino acids in the soybean foods, particularly in fermented soybean foods such as Miso, Natto and Tempe (Indonesian soy bean paste).

The content of the free amino acids in Miso is known to be increased during the aging period. However, aging periods of as long as 5 to 12 months for rice Miso, 1 to 12 months for barley Miso, and 5 to 20 months for soybean Miso are usually required (Fumio Yamauchi and Kazuyoshi Ohkubo, ed., Science of Soybean, Asakura Publishing Co.).

An increase of the contents of the free amino acids have been usually observed within 20 hours of fermentation in Natto. While the contents of glutamic acid, leucine and alanine are in the range of 400 to 600 mg per 100 g (dry weight) of Natto, the contents of other amino acids are 200 mg or lower. It is also reported that the total content of the free amino acids is about 5% per unit weight of the dry Natto (Tokuji Watanabe, Soybean Food, 123, Korin Publishing Co.).

The content of the free amino acids in Tempe also increases during the fermentation period (Nippon Shokuhin Kogaku Kaishi, Vol. 137, No. 2, 130-138, 1990). While the amount of increase is 200 mg or more for glutamic acid, proline and alanine per 100 g (dry weight) of Tempe after 28 hours' fermentation, the amounts of increase of other amino acids are 100 mg or lower. The total content of the free amino acids is as low as about 1% by weight per unit weight of the dry Tempe.

The methods for increasing the content of γ-aminobutyric acid in soybean and in the fermented soybean foods such as Miso, Natto and Tempe have been studied as follows.

The content of γ-aminobutyric acid is about 50 mg/100 g (wet weight) of Miso (Nippon Jouzou Kyokai Kaishi, Vol. 192, No.9, 689, 1997), and Natto contains substantially no γ-aminobutyric acid (Seibutu Kougaku Kaishi, Vol. 175, No. 4, 239-244, 1997). The content of γ-aminobutyric acid in Tempe has not been confirmed yet.

Accordingly, JP 11-103825A discloses a method for remarkably increasing the content of γ-aminobutyric acid for the purpose of developing Miso rich in γ-aminobutyric acid, wherein Koji molds, soybean and water are mixed to accelerate conversion to γ-aminobutyric acid, followed by fermentation by adding sodium chloride, yeast and lactobacillus.

However, the content of γ-aminobutyric acid was still as low as 112 mg/100 (wet weight) in the Miso developed by the method described above.

Since it has been known that Koji molds is related to the content of γ-aminobutyric acid in Miso, increasing the content of γ-aminobutyric acid has been also studied using Koji molds.

JP 11-151072A proposes a soybean food product rich in γ-aminobutyric acid, wherein the content of γ-aminobutyric acid in soybean is markedly increased by soaking at least one of soybean containing the soybean germ, soybean germ and soybean without the germ, or a degreased product thereof, in water.

However, the content of γ-aminobutyric acid was also low (about 120 mg/100 g of the wet weight) in the products produced by the method above.

The physiological activity was low in the food materials rich in γ-aminobutyric acid using soybean as compared with tea and rice rich in γ-aminobutyric acid, and only tea and rice rich in γ-aminobutyric acid have been recognized to be the materials having various physiological activities (Food Style 21, Vol. 5, No. 5, 2001).

Fermented soybean foods, which are produced by fermentation technologies using only soybean as a natural food material, and which have various physiological functions of γ-aminobutyric acid and contain a high concentration of tasting amino acids, remains undeveloped. These fermented foods are also required to contain effective ingredients such as proteins, peptides, antioxidant, vitamins, minerals and isoflavone originating from soybean and fermented soybean products while having a elevation of systolic blood pressure.

The methods for increasing the contents of γ-aminobutyric acid and other free amino acids using cereals other than soybean, in particular using tea and rice, have been studied and developed as follows:

(1) The content of γ-aminobutyric acid has been known to increase as the content of glutamic acid decreases, when tea leaves are placed under an anaerobic condition such as in a nitrogen or carbon dioxide atmosphere. The processed tea produced by this method is now commercially available by the name of Gyabaron tea. However, since γ-aminobutyric acid is diluted by extracting the tea leaves produced by this method with hot water, a large volume of tea should be taken.

(2) JP 7-213252A, JP 8-280394A and JP 9-107920A, and Chemistry and Biology (Vol. 33, No.4, 1994) disclose methods for remarkably increasing the contents of γ-aminobutyric acid and free amino acids by soaking rice germ in water. However, a large quantity of germ accounting for only 3% in rice should be collected for applying this method.

(3) JP 10-165191A and JP 11-103825A, and Nippon Nougeikogaku Kaishi (Vol. 66, No. 8, 1241-1246, 1992) propose methods for producing γ-aminobutyric acid by a solid fermentation or liquid fermentation using Aspergillus oryzae or Monascus pilosus, and methods for producing γ-aminobutyric acid using cell free extract of Koji molds. While fermented food products containing effective ingredients of the natural food materials originating from rice as well as γ-aminobutyric acid are obtained by the solid fermentation using rice as a starting material, the content of γ-aminobutyric acid is low (about 60 mg/100 g of dry weight for Monascus pilosus, and about 76 mg/100 g of dry weight for Aspergillus oryzae). Fermentation technologies using cereals other than rice such as beans (azuki bean and black soybean), seeds (peanuts and sesame) and miscellaneous cereals (corn and buckwheat) have not been studied yet. In the methods by the liquid fermentation and using cell free extract of Koji molds, on the other hand, the content of γ-aminobutyric acid is increased by adding glutamic acid or salts thereof. However, the taste of the food may be changed due to the presence of excess glutamic acid, or the color of the food material may turn into brown by an aminocarbonyl reaction between excess glutamic acid and glucide caused by heating for sterilization. In addition, the contents of other natural effective ingredients such as proteins, amino acids and antioxidant may be decreased.

Fermented food products are required to contain a high concentration of γ-aminobutyric acid as well as effective ingredients originating from cereals and fermented products such as proteins, amino acids and antioxidant. However, production of such food products by the fermentation technology using only cereals, or natural food materials, as starting materials has not been developed yet.

### DISCLOSURE OF INVENTION

The first object of the present invention in relation to the problems as hitherto described is to provide a process for producing fermented soybean foods rich in γ-aminobutyric acid using only soybean as a natural food material by fermentation using Tempe molds, whereby the fermented soybean food becomes rich in γ-aminobutyric acid while containing effective ingredients originating from soybean and fermented soybean products such as proteins, amino acids and antioxidant.

In a first aspect for attaining the object described above, the invention as recited in claim 1 of the present invention is characterized in that a process for producing fermented soybean foods rich in γ-aminobutyric acid is carried out by fermentation of soybean using Tempe molds.

The invention as recited in claim 2 depended on claim 1, the Tempe mold belongs to genus Rhizopus.

The invention as recited in claim 3 depended on claim 1, the genus Rhizopus may be Rhizopus oligosporus or Rhizopus oryzae.

The invention as recited in claim 4 depended on claim 1, the fermented soybean food rich in γ-aminobutyric acid may also contain effective ingredients originating from soybean and fermented soybean products such as proteins, amino acids and antioxidant.

The first aspect of the present invention will be described in detail hereinafter.

The inventors of the present invention have investigated microorganisms having an ability to produce γ-aminobutyric acid from the microorganisms that had been used for production of foods, and found that molds belonging to genus Rhizopus used in producing a traditional fermented soybean food “Tempe” in Indonesia are able to produce a large quantity of γ-aminobutyric acid by fermentation on a solid medium using soybean as a starting material, thereby conceiving the present invention.

While the mold to be used in the present invention belongs to genus Rhizopus, any molds may be used provided they belong to genus Rhizopus having an ability to produce γ-aminobutyric acid, and examples of them include Rhizopus oligosporus, Rhizopus oryzae, Rhizopus achlamydosporus and Rhizopus stolonifer. However, Rhizopus oligosporus and Rhizopus oryzae having a high ability for producing γ-aminobutyric acid are particularly preferable. Mutants derived from the mold according to the present invention and having the ability for producing γ-aminobutyric acid may be used as well. Since Rhizopus oligosporus and Rhizopus oryzae to be used in the present invention are the molds that have been used for Tempe that is a traditional fermented soybean food in Indonesia as hitherto described, they can be widely used in the field of food industry without any problem in safety.

It is desirable as the culture medium for culturing the mold to be used in the present invention that the molds as described above can grow well to produce objective γ-aminobutyric acid on the medium.

Soybean may be used as the material of the solid culture medium, including any soybean harvested in Japan, China, United States and Canada.

Soybean is soaked in acidic water, followed by drain and dehull. Any edible organic acids including acetic acid, citric acid, lactic acid and tartaric acid may be used for the acidic soak solution. It is desirable that the acid is added in a concentration that does not inhibit the growth of the mold belonging to genus Rhizopus, and preferable concentration of acetic acid is, for example, 0.2 to 0.5% by weight. While soybean after the soaked treatment is dehulled after drain, it is desirable that no residues of the soybean hull are present in soybean as the starting material. The dehull process may be omitted by using dehulled soybean as the starting material. Then, soaked soybean is boiled under an atmospheric pressure and in a pressure vessel. The boiling time in acidic water is desirably 30 to 90 minutes while pressurized boiling is desirably performed at 120° C. for 2 to 5 minutes. Soybean after boiling and pressurized boiling is cooled before use. Subsequently, a suspension solution of spinhole or freeze-dried cells of genus Rhizopus molds are added to the boiled soybean to use it as a seed mold. While 0.1 to 50% by weight of the spinholeuspension or freeze-dried cells are added, a proportion of 0.5 to 3.0% by weight is preferable. The seed mold is added to the boiled soybean, which is fermented by filling in a plastic bag with pinhole on the surface or by spreading on a stainless steel tray, so that the thickness of boiled soybean becomes about 1.5 cm. The fermentation conditions comprise a temperature of 20 to 45° C., preferably 30 to 40° C.; a relative humidity of 60% or more, preferably 80 to 98%; an initial pH of 3.0 to 7.0, preferably 4.0 to 5.0; and fermentation time of 10 to 50 hours, preferably 15 to 30 hours.

A fermented food rich in γ-aminobutyric acid and containing effective ingredients originating from soybean and fermented soybean products such as proteins, amino acids and antioxidant may be obtained with no leak of the ingredient by fermentation of Tempe mold under the conditions as described above.

Although the fermented food according to the present invention may be directly used, it may be also used after sterilization by wet heating or dry heating, or by using a microwave, followed by pulverization, forming into a paste, or drying by means of freeze-drying or air-stream drying, if necessary.

The object of the present invention is related to a process for obtaining a fermented food rich in γ-aminobutyric acid while containing effective ingredients originating from soybean and fermented soybean products such as proteins, amino acids and antioxidant by fermentation using Tempe molds belonging to genus Rhizopus on a solid culture medium comprising soybean as a fermentation material. Accordingly, the method of use of the fermented food is not restricted in any sense in the present invention.

The second object of the present invention is to provide fermented soybean foods rich in γ-aminobutyric acid and other free amino acids and a production process thereof using only soybean as a natural food material by fermentation of soybean using Tempe mold belonging to genus Rhizopus with an anaerobic treatment. The fermented soybean food is rich in γ-aminobutyric acid having various physiological functions and tasting free amino acids while containing effective ingredients originating from soybean and fermented soybean products such as proteins, peptides, antioxidant, vitamins, minerals, isoflavone and angiotensin conversion enzyme inhibitors in addition to a elevation of systolic blood pressure.

In a second aspect for attaining the object above, the present invention provides fermented soybean foods rich in γ-aminobutyric acid and free amino acids and a method for producing the same by fermentation using Tempe mold belonging to genus Rhizopus with an anaerobic treatment.

The mold belonging to genus Rhizopus may be Rhizopus oligosporus or Rhizopus oryzae.

Preferably, the quantity (g) of the fermented soybean products charged in an airtight vessel is 0.005 to 1.0 g/cm³.

Preferably, the anaerobic treatment time is 30 minutes or more for enriching γ-aminobutyric acid and 5 hours or more for enriching the free amino acids after reducing the oxygen concentration to 1% or lower.

Preferably, the content of γ-aminobutyric acid is 0.3% by weight or more per unit dry weight of the fermented soybean product, and the content of the free amino acids is 5% by weight or more per unit dry weight of the fermented soybean product.

The present invention also provides a process for producing fermented soybean foods rich in γ-aminobutyric acid and free amino acids containing effective ingredients originating from soybean and fermented soybean products such as proteins peptides, vitamins, antioxidant, minerals, isoflavone and angiotensin conversion enzyme inhibitors.

The fermented soybean foods rich in γ-aminobutyric acid and free amino acids may be obtained by the process as hitherto described.

Preferably, the fermented soybean food has a elevation of systolic blood pressure effect.

Preferably, the fermented soybean food has a food function enrichment effect.

The second aspect of the present invention will be described in detail hereinafter.

The inventors of the present invention have investigated microorganisms having an ability to produce γ-aminobutyric acid from the microorganisms that had been used for production of foods, and found that molds belonging to genus Rhizopus used in producing a traditional fermented soybean food in Indonesia—Tempe—are able to produce a large quantity of γ-aminobutyric acid as well as free amino acids such as lysine by fermentation on a solid medium using soybean as a starting material, thereby conceiving the present invention.

While the mold to be used in the present invention belongs to genus Rhizopus, any molds may be used provided they belong to genus Rhizopus having an ability to produce γ-aminobutyric acid, and examples of them include Rhizopus oligosporus, Rhizopus oryzae, Rhizopus achlamydosporus and Rhizopus stolonifer. However, Rhizopus oligosporus and Rhizopus oryzae having a high ability for producing γ-aminobutyric acid are particularly preferable. Mutants derived from the mold according to the present invention and having the ability for producing γ-aminobutyric acid may be used as well. Since Rhizopus oligosporus and Rhizopus oryzae to be used in the present invention are the molds that have been used for Tempe that is a traditional fermented soybean food in Indonesia as hitherto described, they can be widely used in the field of food industry without any problem in safety.

It is desirable as the culture medium for culturing the mold to be used in the present invention that the molds as described above can grow well to produce objective γ-aminobutyric acid on the medium.

Soybean may be used as the material of the solid culture medium, including any soybean harvested in Japan, China, United States and Canada. Soybean may be used as soybean grains, crushed soybean or cracked soybean whole, half, or cracked soybean.

Soybean is soaked in acidic water, followed by drain and dehull. Any edible organic acids including acetic acid, citric acid, lactic acid and tartaric acid may be used for the acidic soak solution. It is desirable that the acid is added in a concentration that does not inhibit the growth of the mold belonging to genus Rhizopus, and preferable concentration of acetic acid is, for example, 0.2 to 0.5% by weight. While soybean after the soaked treatment is dehulled after drain, it is desirable that no residues of the soybean hull are present in soybean as the starting material. The dehull process may be omitted by using dehulled soybean as the starting material. Then, soaked soybean is boiled under an atmospheric pressure and in a pressure vessel. The boiling time in acidic water is desirably 30 to 90 minutes while pressurized boiling is desirably performed at 120° C. for 2 to 5 minutes.

Soybean after boiling and pressurized boiling is cooled before use. Subsequently, a suspension solution of spinhole or freeze-dried cells of genus Rhizopus mold are added to the boiled soybean to use it as a seed mold. While 0.1 to 50% by weight of the spinholeuspension or freeze-dried cells are added, a proportion of 0.5 to 3.0% by weight is preferable.

The seed mold is added to boiled soybean, which is fermented by filling in a plastic bag with pinhole on the surface or by spreading on a stainless steel tray, so that the thickness of boiled soybean becomes about 1.5 cm.

The fermentation conditions comprise a temperature of 20 to 45° C., preferably 30 to 40° C.; a relative humidity of 60% or more, preferably 80 to 98%; an initial pH of 3.0 to 7.0, preferably 4.0 to 5.0; and fermentation time of 10 to 50 hours, preferably 15 to 30 hours.

Soybean is subjected to an anaerobic treatment after fermentation in the present invention. The anaerobic treatment as used herein means storing the fermented product as a starting material under an anaerobic condition for a given period of time. For example, the treatment include storing the fermented product in an airtight vessel, replacing the air in the airtight vessel with an inert gas, or evacuating the airtight vessel with a pump.

The inside of the airtight vessel becomes anaerobic due to oxygen consumption of the mold itself and generation of carbon dioxide by the mold, even when the initial oxygen concentration is 20.95% as the oxygen concentration in the air, thereby enabling the content of the free amino acids such as γ-aminobutyric acid to be increased.

It is recommended to increase the charge volume of the fermented soybean in order to effectively proceed the reaction, because the larger charge volume increases the amount of oxygen consumed to facilitate the inside of the vessel to be anaerobic. The initial oxygen concentration may be reduced in order to allow the content of γ-aminobutyric acid and free amino acids to be increased within a short period of time.

While preferable anaerobic condition is attained by charging 0.005 to 1.0 g of the fermented soybean product per unit volume (cm³) of the airtight vessel, the volume ratio is preferably 0.05 g/cm³ when the initial oxygen concentration is 20.95%, and 0.01 g/cm³ when the initial oxygen concentration is as low as 0.1%.

The anaerobic treatment time is desirably 30 minutes or more for enrichment of γ-aminobutyric acid, and 5 hours or more for enrichment of the free amino acids after the oxygen concentration has reduced to 1% or lower. The longer anaerobic time is more preferable. The temperature for the anaerobic treatment is 5 to 50° C., preferably 25 to 40° C. The initial pH is in the range of 3.0 to 7.0, desirably in the range of 4.0 to 6.0. The initial pH is adjusted to the acidic side because the optimum pH values of glutamic acid decarboxylase and protease for the biosynthesis of γ-aminobutyric acid and free amino acids are shifted to an acidic side.

The fermented soybean food may be obtained by fermentation of Tempe mold under the conditions as described above, whereby fermented soybean food contains amino acids such as γ-aminobutyric acid, lysine, arginine, tyrosine and methionine that are considered to have a elevation of systolic blood pressure effect as well as isoflavone, potassium and angiotensin conversion inhibitor. The fermented soybean food also becomes rich in other tasting free amino acids having various physiological functions while containing proteins, peptides, vitamins, antioxidant and minerals.

Although the fermented food according to the present invention may be directly used, it may be also used after sterilization by wet heating or dry heating, or by using a microwave, followed by pulverization or extraction of water-soluble components. The fermented food may be also used after drying by means of freeze-drying or air-stream drying, if necessary.

While the fermented food according to the present invention may be directly taken, the functional components included in the fermented food may be readily enriched in various foodstuffs by adding a powder, extraction or paste of the fermented food.

The object of the present invention is related to the fermented soybean food and a process for obtaining a fermented soybean food rich in γ-aminobutyric acid having various physiological functions and tasting free amino acids by fermentation of soybean materials in a solid fermentation medium with an anaerobic treatment using Tempe mold belonging to genus Rhizopus. The fermented soybean food also contains effective ingredients originating from soybean and soybean fermented products such as peptides, vitamins, antioxidant, minerals and isoflavone while having a elevation of systolic blood pressure effect. Accordingly, the method of use of the fermented food is not restricted in any sense in the present invention.

The third object of the present invention is to provide a process for producing fermented cereal foods rich in γ-aminobutyric acid and free amino acids by fermentation of cereals by Koji molds with an anaerobic treatment using the cereals as natural food materials. The fermented cereal food becomes rich in tasting free amino acids having various physiological functions such as γ-aminobutyric acid, valine, isoleucine and lysine while containing vitamins, anthocyanin, sesamin, isoflavone, soybean saponin, phytic acid and antioxidant originating from the cereals as well as digested proteins, peptides and antioxidant originating from the fermented cereal products.

In the third aspect for attaining the object above, the present invention provides a process for manufacturing fermented cereal food rich in γ-aminobutyric acid and free amino acids by fermentation of cereals using Koji molds.

The present invention also provides a process for producing fermented cereal foods rich in γ-aminobutyric acid and free amino acids by an anaerobic treatment after fermentation of cereals using Koji molds.

Preferably, the Koji mold belongs to genus Rhizopus.

More preferably, the Koji mold belonging to genus Rhizopus is Rhizopus oligosporus or Rhizopus oryzae.

The Koji mold may belong to genus Aspergillus.

More preferably, the Koji mold belonging to genus Aspergillus is Aspergillus oligosporus or Aspergillus niger.

The total content of γ-aminobutyric acid and free amino acids preferably accounts for 1% by weight or more per unit dry weight of the fermented cereal products.

The cereals used for the fermented cereal foods rich in γ-aminobutyric acid and free amino acids may include beans, seeds, wheat and barley and miscellaneous cereals.

Only bran as refining residues of cereals, isolated germ or total grains of cereals including these residues may be used for the fermented cereal foods rich in γ-aminobutyric acid and free amino acids.

The third aspect of the present invention will be described in detail hereinafter.

The inventors of the present invention have investigated microorganisms having an ability to produce γ-aminobutyric acid from the microorganisms that had been used for production of foods, and found that a large scale production of γ-aminobutyric acid is possible by fermentation by Koji molds using a solid medium comprising a cereal material, thereby conceiving the present invention.

Any Koji molds that has an ability for producing free amino acids such as γ-aminobutyric acid may be used for the mold in the present invention. The Koji molds belonging to genus Rhizopus, Aspergillus, Penicillium, Mucor, and Monascus that have been used for producing fermented foods in the food industry without any safety problems may be used in the present invention. These Koji molds include Rhizopus oligosporus, Rhizopus oryzae, Rhizopus achlamydosporus, Rhizopus stolonifer, Aspergillus oryzae, Aspergillus niger, Aspergillus kawachi, Aspergillus glaucus, Aspergillus sojae, Aspergillus taramii, Penicillium chrysogenum, Penicillium roquefortii, Penicillium camembertii, Penicillium citrinum, Mucor silvaticus and Monascus purpureus. However, Rhizopus oligosporus, Rhizopus oryzae, Aspergillus oryzae and Aspergillus niger having a high ability for producing γ-aminobutyric acid and free amino acids are particularly preferable. Mutants induced from the Koji molds and having a high ability for producing γ-aminobutyric acid and free amino acids may be also used as well.

It is desirable to use a fermentation medium on which the mold grows well to produce desired γ-aminobutyric acid and free amino acid for cultivation of the mold to be used in the present invention.

The cereals to be used for solid fermentation include beans (azuki beans, black soybeans, green soybeans, green peas, kidney beans and common peass), seeds (peanuts, sesame, peach seed and walnut), wheat and barley (barley, wheat, oat and Job's drop) and miscellaneous cereals (corn, buckwheat, millet, common millet and Italian millet). Edible portion of cereals such as germs and bran may be also used.

The cereals as starting materials are heated after swelling. For example, dry beans (such as azuki bean and black soybeans) are used after swelling by soaking in acidic water. Cereals such as barley, wheat, millet and common millet mainly comprising starch are soaked in water for swelling, followed by heating. Only heating is necessary for cereals containing a large quantity of water (fresh cereals, processed cereals and frozen cereals) without soaking. The cereals are desirably sterilized by heating in an acidic solution for 30 to 90 minutes. Alternatively, the cereals are desirably heated under a pressure at 120° C. for 2 to 15 minutes. The cereals heated in an acidic solution are used after cooling.

Then, a suspension of spinhole or freeze-dried cells of the rice Koji molds is added to the cereals after heating to use it as seed molds. The proportion of addition of the suspension of spinhole or freeze-dried cells is 0.1 to 50% by weight, preferably 0.5 to 3.0% by weight.

The seed molds are added to the heated cereals, which are fermented by filling in a plastic bag with pinhole on the surface or by spreading in a vessel such as a stainless steel tray or flask, so that the thickness of boiled cereals become about 1.5 cm.

The fermentation conditions comprise a temperature of 20 to 45° C., preferably 30 to 40° C.; a relative humidity of 60% or more, preferably 80 to 98%; an initial pH of 3.0 to 7.0, preferably 4.0 to 5.0; and fermentation time of 10 to 50 hours, preferably 15 to 30 hours.

The cereals are subjected to an anaerobic treatment after fermentation. The anaerobic treatment as used herein means storing the fermented product as a starting material under an anaerobic condition for a given period of time. For example, the treatment include storing the fermented product in an airtight vessel, replacing the air in the airtight vessel with an inert gas, or evacuating the airtight vessel with a pump.

The inside of the airtight vessel becomes anaerobic due to oxygen consumption of the mold itself and generation of carbon dioxide by the mold, even when the initial oxygen concentration is 20.95% as the oxygen concentration in the air, thereby enabling the content of the free amino acids such as γ-aminobutyric acid to be increased.

It is recommended to increase the charge volume of the fermented cereals in order to effectively proceed the reaction, because the larger charge volume increases the amount of oxygen consumed to facilitate the inside of the vessel to be anaerobic. The initial oxygen concentration may be reduced in order to allow the content of γ-aminobutyric acid and free amino acid to be increased within a short period of time.

While preferable anaerobic condition is attained by charging 0.005 to 1.0 g of the fermented cereals product per unit volume (cm³) of the airtight vessel, the volume ratio is preferably 0.05 g/cm³ or more when the initial oxygen concentration is 20.95%, and 0.01 g/cm³ or more when the initial oxygen concentration is a s low as 0.1%.

The anaerobic treatment time is desirably 30 minutes or more for enrichment of γ-aminobutyric acid, and 5 hours or more for enrichment of the free amino acids after the oxygen concentration has reduced to 1% or lower. The longer anaerobic time is more preferable. The temperature for the anaerobic treatment is 5 to 50° C., preferably 25 to 40° C. The initial pH is in the range of 3.0 to 7.0, desirably in the range of 4.0 to 6.0. The initial pH is adjusted to the acidic side because the optimum pH values of glutamic acid decarboxylase and protease for the biosynthesis of γ-aminobutyric acid and free amino acids are shifted to an acidic side. Although the content of γ-aminobutyric acid before the anaerobic treatment is 0.01% by weight or more, or sometimes 0.1% by weight or more, it may be reliably increased to as high as 0.1% by weight or more by applying fermentation and anaerobic treatment as described above. Similarly, although the content of the free amino acids before the anaerobic treatment is 0.1% by weight or more, or sometimes 1% by weight or more, it may be reliably increased to as high as 1% by weight or more by applying fermentation and anaerobic treatment as described above.

Fermented foods rich in γ-aminobutyric acid and free amino acids can be obtained by cultivation of the mold under the conditions as described above. The fermented foods also contain effective ingredients originating from the cereals, for example vitamin B group contained in azuki beans, black soybeans, green soybean, peanuts, sesame, peach seeds, buckwheat, millet, germs and bran; vitamin E contained in black soybeans, peach seeds, peanuts and germs; anthocyanin contained in azuki beans and black soybeans; sesamin contained in sesame; isoflavone contained in black soybeans; soybean saponin and phytic acid contained in germ and bran; dietary fibers; and minerals and antioxidant contained in azuki beans, black soybeans, green soybean, sesame, valley, wheat, oat, Job's tea, common millet, Italian millet, germ and bran, as well as digested proteins, peptides and antioxidant originating from fermented cereal products.

While the fermented foods according to the present invention can be directly used, they may be used as a paste or an extract of the water soluble components after sterilizing by wet heating or dry heating, or by using a microwave followed by pulverization. The fermented foods are further utilized by freeze-drying or drying in an air stream.

The present invention relates to a process for manufacturing a fermented food rich in γ-aminobutyric acid having various physiological functions and tasting free amino acids by fermentation with an anaerobic treatment by Koji molds using a solid medium comprising cereals as starting materials. Accordingly, use of the fermented foods are not restricted in any sense.

### BRIEF DESCRIPTION OF THE DRAWINGS

FIG. 1 is a graph showing the experimental results of the elevation of systolic blood pressure effect of the fermented soybean food according to the second aspect of the present invention.

### BEST MODE FOR CARRYING OUT THE INVENTION

The embodiments of the present invention will be described with reference to examples.

Examples 1 to 4 in the following examples correspond to the first embodiment of the present invention.

### EXAMPLE 1

Boiled soybean was prepared by boiling 100 g of dehulled soybeans at 120° C. for 5 minutes after soaking in 300 ml of 0.2% acetic acid solution. Then, a suspension of the spore of Rhizopus oligosporus IF08631 was added to and mixed with the boiled soybean in a proportion of 1% by weight. After filling the boiled soybean in a plastic bag with pinhole on the surface so that the thickness becomes about 1.5 cm, the boiled soybean was fermented at 37° C. for 20 hours. After the fermentation, the fermented soybean was freeze-dried and precisely weighed, and γ-aminobutyric acid was extracted with 8% trichloroacetic acid.

The content of extracted γ-aminobutyric acid was determined with an amino acid autoanalyzer. As shown in Table 1, the fermented product contained a high concentration of γ-aminobutyric acid of 217 mg/100 g dry weight.

TABLE 1
CONTENT OF γ-AMNIBUTYRIC ACID IN
FERMENTED SOYBEAN PRODUCT

| | CONTENT OF γ-AMINOBUTYRIC |
|---|---|
| | IN FERMENTED SOYBEAN PRODUCT |
| CONTENT OF | 217 |
| γ-AMINOBUTYRIC | |
| ACID (mg/100 g dry) | |

### EXAMPLE 2

The content of γ-aminobutyric acid in the fermented soybean product prepared by using Rhizopus oligosporus IF08631 was compared with those in commercially available fermented soybean food—Natto (commercially available Natto), Miso (commercially available Miso) and Tempe (commercially available Tempe)—and in the boiled soybean. The content of γ-aminobutyric acid in each sample was also measured with an amino acid autoanalyzer according to the method in Example 1. As shown by the results in Table 2, the content of γ-aminobutyric acid in the fermented soybean product prepared using Rhizopus oligosporus IF08631 was the highest among the samples.

TABLE 2
COMPARISON OF THE CONTENT OF γ-AMINOBUTYRIC
ACID IN VARIOUS FERMENTED SOY BEAN FOODS

| | γ-AMINOBUTYRIC ACID |
|---|---|
| | (mg/100 g dry) |
| FERMENTED SOYBEAN PRODUCT | 217 |
| COMMRCIALLY AVAILABLE NATTO | 30 |
| COMMRCIALLY AVAILABLE MISO | 36 |
| COMMRCIALLY AVAILABLE TEMPE | 12 |
| BOILED SOYBEAN | 26 |

### EXAMPLE 3

Dehulled soybeans (100 g) were soaked in 300 ml of 0.2% acetic acid solution for 12 hours and boiled at 120° C. for 5 minutes to prepare the boiled soybean. Subsequently, spinholeuspension solutions of several mold strains belonging to genus Rhizopus were added to the boiled soybean in a proportion of 1% by weight followed by mixing to prepare fermented soybean products of respective mold strains of genus Rhizopus. The content of γ-aminobutyric acid in each sample was measured with an amino acid autoanalyzer according to the method in Example 1. γ-Aminobutyric acid production ability was observed in each mold strain of genus Rhizopus as shown Table 3.

TABLE 3
PRODUSTION OF γ-AMINOBUTYRIC ACID BY MOLDS
BELONGING TO GENUS RHIZOPUS

| | CONTANT OF γ- |
|---|---|
| | AMINOBUTYLIC ACID |
| | (mg/100 g dry) |
| Rhizopus oligosporous IF08631 | 217 |
| Rhizopus oryzae IF04705 | 143 |
| Rhizopus oryzae IF05438 | 101 |
| Rhizopus oryzae IF05780 | 66 |
| (Rhizopus arrhizus) | |
| Rhizopus oryzae IF04770 | 102 |
| (Rhizopus achlamydosporus) | |
| Rhizopus oryzae IF04732 | 65 |
| (Rhizopus formosaensis) | |
| Rhizopus stolonifer IF06188 | 43 |

### EXAMPLE 4

Dehulled soybean (100 g) was boiled after soak to prepare boiled soybean according to the method in Example 1. A suspension of the spinhole of Rhizopus oligosporus IF08631 was added to and mixed with the boiled soybean in a proportion of 1% by weight, and the mixture was cultivated at 37° C. for 20 hours. After the cultivation, the fermented product was freeze-dried. The content of γ-aminobutyric acid in the freeze-dried product was measured according to Example 1 using an amino acid autoanalyzer. A superoxide dismutase (SOD)-like activity of antioxidant was also measured using a SOD test Wako (NBT reduction method) made by Wako Pure Chemicals Co. The γ-aminobutyric acid content and SOD-like activity of Natto were also measured for comparison. As shown in Table 4, the fermented soybean product (fermented soybean preparation) by Rhizopus oligosporus IF08631 had a higher content of γ-aminobutyric acid and higher SOD-like activity as compared with those of Natto.

TABLE 4
CONTENT OF γ-AMINOBUTYRIC ACID AND SOD-LIKE
ACTIVITY OF FERMENTED SOYBEAN PRODUCT BY Rhizopus
oligosporus IF08631

| | CONTENT OF γ- | SOD-LIKE ACTIVITY |
|---|---|---|
| | AMINOBUTYRIC | (INHIBITION |
| | ACID (mg/100 g dry) | RATIO %) |
| FERMENTED | 217 | 51 |
| SOYBEAN | | |
| PRODUCT BY | | |
| Rhizopus | | |
| oligosporus IF08631 | | |
| NATTO | 36 | 24 |

Examples corresponding to the second embodiment of the present invention will be described hereinafter with reference to Examples 5 to 13.

### EXAMPLE 5

Dehulled soybean (100 g) was soaked in 300 ml of 0.2% acetic acid solution for 12 hours, followed by boiling at 120° C. for 5 minutes to prepare boiled soybean. Then, a suspension of spinhole of Rhizopus oligosporus IF08631 was added to the boiled soybean in a proportion of 1% by weight. The mixture was filled in a plastic bag with pinhole on the surface so that the thickness of the boiled soybean becomes about 1.5 cm, followed by cultivation at 37° C. for 17.5 hours. After the cultivation, 30 g of the fermented product was filled in an airtight vessel with a net volume of 100 ml, and was subjected to an anaerobic treatment at 37° C. for 10 hours after sufficiently purging the vessel with nitrogen. After completing the anaerobic treatment, the product was freeze-dried. The freeze-dried product obtained was precisely weighed, and amino acids including γ-aminobutyric acid were extracted with 8% trichloroacetic acid. Extracted amino acids were analyzed using an amino acid autoanalyzer.

A fermented soybean product containing 7.6% by weight (relative to the dry weight of the product) of total free amino acids and 523 mg/100 g (dry weight of the product) of γ-aminobutyric acid was obtained As shown in Table 5.

TABLE 5
CONTENTS OF γ-AMINOBUTYRIC ACID AND OTHER FREE
AMINO ACIDS IN FERMENTED SOYBEAN PRODUCT

| | CONTENT IN |
|---|---|
| | FERMENTED |
| | SOYBEAN |
| | PRODUCT |
| TOTAL FREE AMINO ACID (% BY DRY WEIGHT) | 7.6 |
| CONTENT OF EACH AMINO ACID (mg/100 g DRY) | |
| γ-AMINOBUTYRIC ACID | 523 |
| VALINE | 280 |
| ISOLEUCINE | 272 |
| HISTIDINE | 250 |
| LYSINE | 506 |
| PHENYLALANINE | 289 |
| THREONONE | 284 |
| ARGININE | 372 |
| GLUTAMINE | 451 |
| GLUTAMIC ACID | 788 |
| TYROSINE | 284 |
| ALANINE | 1270 |

### EXAMPLE 6

Contents of γ-aminobutyric acid in the fermented soybean product prepared using Rhizopus oligosporus IF08631, in commercially available fermeted soybean foods Natto (commercially available Natto), Miso (commercially available Miso), Tempe (commercially available Tempe), and in boiled soybean were compared. The content of γ-aminobutyric acid in each sample was measured according to Example 5 using an amino acid autoanalyzer. As shown in Table 6, the content of γ-aminobutyric acid was the highest in the fermented soybean product prepared by using Rhizopus oligosporus.

TABLE 6
COMPARISON OF THE CONTENT OF γ-AMINOBUTYRIC
ACID IN FERMENTED SOYBEN FOOD

| | γ-AMINOBUTYRIC ACID |
|---|---|
| | (mg/100 g DRY) |
| FERMENTED SOYBEAN PRODUCT | 523 |
| COMMERCIALLY AVAILABLE NATTO | 30 |
| COMMERCIALLY AVAILABLE MISO | 36 |
| COMMERCIALLY AVAILABLE TEMPE | 12 |
| BOILED SOYBEAN | 26 |

### EXAMPLE 7

Dehulled soybean (100 g) was soaked in 300 ml of 0.2% acetic acid solution for 12 hours and boiled at 120° C. for 5 minutes to prepare boiled soybean. Then, a suspension of spinhole of Rhizopus oligosporus IF08631 was added to the boiled soybean in a proportion of 1% by weight. The mixture was fermented by the same method as in Example 5 to prepare a fermented soybean product. After the cultivation, 30 g of the fermented product was charged in an airtight vessel with a net volume of 100 ml, and was subjected to an anaerobic treatment at 37° C. after purging the vessel with nitrogen. The contents of γ-aminobutyric acid and free amino acids were measured according to the method in Example 5 using an amino acid autoanalyzer. As shown in Table 7, remarkable increases of the contents of γ-aminobutyric acid and other amino acids were observed in accordance with the anaerobic treatment time.

TABLE 7
CONTENTS OF γ-AMINOBUTYRIC ACID AND
OTHER AMINO ACIDS IN ACCORDANCE WITH
THE ANAEROBIC TREATMENT TIME

| | 10 | 20 | 50 |
|---|---|---|---|
| | HOURS | HOURS | HOURS |
| CONTENT OF TOTAL AMINO | 7.6 | 12.2 | 16.0 |
| ACID (% BY DRY WEIGHT) | | | |
| OTHER AMINO ACIDS | | | |
| (mg/100 g DRY) | | | |
| γ-AMINOBUTYRIC ACID | 523 | 629 | 673 |
| VALINE | 280 | 527 | 762 |
| ISOLEUCINE | 272 | 529 | 780 |
| HYSTIDINE | 250 | 396 | 491 |
| LYSINE | 506 | 1026 | 1250 |
| PHENYLALANINE | 289 | 589 | 740 |
| THREONINE | 284 | 549 | 696 |
| ARGININE | 372 | 381 | 447 |
| GLUTAMINE | 451 | 366 | 692 |
| GLUTAMIC ACID | 788 | 1182 | 1931 |
| TYROSINE | 284 | 450 | 470 |
| ALANINE | 1270 | 1568 | 1611 |

### EXAMPLE 8

Dehulled soybean (100 g) was soaked in 300 ml of 0.2% acetic acid solution and boiled at 120° C. for 5 minutes to prepare boiled soybean. Then, a suspension of spinhole of each genus Rhizopus was added to and mixed with the boiled soybean in a proportion of 1% by weight. Each mixture was fermented at 30° C. for 20 to 22 hours as in Example 5 followed by 20 hours' anaerobic treatment, thereby preparing fermented soybean products by respective genera Rhizopus. The contents of γ-aminobutyric acid and free amino acids in each sample were determined by the method in Example 5 using an amino acid autoanalyzer. As shown in Table 8, fermented soybean products rich in γ-aminobutyric acid and other amino acids were obtained using respective genera Rhizopus.

TABLE 8
PRODUCTION OF γ-AMINOBUTYRIC ACID AND FREE AMINO
ACIDS BY GENERA Rhizopus

| | CONTENT OF γ- | CONTENT OF FREE |
|---|---|---|
| | AMINOBUTYRIC | AMINO ACID |
| | ACID (mg/100 g DRY) | (% BY DRY WEIGHT) |
| Rhizopus oligosorus | 629 | 12.2 |
| IF08631 | | |
| Rhizopus oligosorus | 819 | 9.8 |
| IF031987 | | |
| Rhizopus oligosorus | 1891 | 12.7 |
| IF032002 | | |
| Rhizopus oligosorus | 1735 | 12.2 |
| IF032003 | | |
| Rhizopus oryzae | 818 | 9.4 |
| IF04705 | | |
| Rhizopus oryzae | 797 | 9.0 |
| IF05438 | | |
| Rhizopus oryzae | 621 | 10.7 |
| IF09364 | | |
| Rhizopus oryzae | 424 | 8.5 |
| IF05780 | | |
| (Rhizopus arrhizus) | | |
| Rhizopus oryzae | 520 | 9.3 |
| IF04770 (Rhizopus | | |
| achlamydosporus) | | |

### EXAMPLE 9

Dehulled soybean (100 g) was soaked in 300 ml of 0.2% acetic acid for 12 hours, and was boiled at 120° C. for 5 minutes to prepare boiled soybean. Then a suspension of spinhole of Rhizopus Oligosporus IF08631 were added to and mixed with the boiled soybean in a proportion of 1% by weight. After fermentation of the mixture at 37° C. for 20 hours by the same method a sin Example 5, the fermented product was charged in an airtight vessel with a net volume of 1 L for an anaerobic treatment with various inert gas. For an anaerobic treatment by evacuation with a vacuum pump, 100 g of the fermented product was placed in a desiccator with a controlled degree of vacuum at room temperature. The content of γ-aminobutyric acid in each sample was measured with an amino acid autoanalyzer according to the method in Example 5. As shown in Table 9, a remarkable increase of γ-aminobutyric acid was observed by each anaerobic treatment using various inert gas and by evacuation with a vacuum pump.

TABLE 9
CONTENT OF γ-AMINOBUTYRIC ACID IN FERMETED
BOYBEAN PRODUCT BY ANAEROBIC TREATMENT

| | CONTENT OF γ- |
|---|---|
| | AMINOBUTYRIC ACID |
| TREATMENT METHOD | (mg/100 g DRY) |
| NITROGEN PURGING, | 629 |
| TREATMENT TIME 20 HOURS | |
| CARBON DIOXIDE PURGING, | 543 |
| TREATMENT TIME 20 HOURS | |
| ARGON PURGING, TREATMENT | 819 |
| TIME 20 HOURS | |
| AIRTIGHT SEALING, TREATMENT | 184 |
| TIME 20 HOURS | |
| AIR, TREATMENT TIME 20 HOURS | 71 |
| VACUUM 90 TORR, TREATMENT | 584 |
| TIME 5 HOURS | |
| VACUUM 10 TORR, TREATMENT | 454 |
| TIME 5 HOURS | |

### EXAMPLE 10

Dehulled soybean (100 g) was soaked in 300 ml of 0.2% acetic acid for 12 hours, and boiled at 120° C. for 5 minutes to prepare boiled soybean. Then, a suspension of spinhole of Rhizopus oligosporus IF08631 was added to and mixed with the boiled soybean in a proportion of 1% by weight. After fermentation of the mixture for 20 hours by the same method as in Example 5, the mixture was subjected to an anaerobic treatment for 5 hours by changing the amount of the fermented soybean product relative to the volume of the airtight vessel under various initial oxygen concentration, thereby preparing a fermented soybean product. The content of γ-aminobutyric acid in each sample was measured according to the method in Example 5 using an amino acid autoanalyzer. As shown in Table 10, fermented soybean product rich in γ-aminobutyric acid could be more effectively obtained as the proportion of the charged fermented soybean product is higher and the initial oxygen concentration is lower.

TABLE 10
EFFECT OF THE AMOUNT (g) OF CHARGING
OF FERMENTED SOYBEAN PRODUCT PER UNIT
VOLUME OF AIRTIGHT VESSEL

| INITIAL | AMOUNT OF CHARGED | CONTENT OF γ- |
|---|---|---|
| OXYGEN | FERMENTED SOYBEAN | AMINOBUTYRIC |
| CONCENTRATION | PRODUCT (g)/VOLUME OF | ACID |
| (%) | AIRTIGHT VESSEL (cm³) | (mg/100 g DRY) |
| 20.9 | 0.16 | 481 |
| 20.9 | 0.05 | 462 |
| 20.9 | 0.01 | 174 |
| 1.0 | 0.16 | 512 |
| 1.0 | 0.05 | 483 |
| 1.0 | 0.01 | 356 |

### EXAMPLE 11

Dehulled soybean (100 g) was soaked in 300 ml of 0.2% acetic acid for 12 hours, and was boiled at 120° C. for 5 minutes to prepare boiled soybean in a proportion of 1% by weight. Then, a suspension of spinhole of Rhizopus Oligosporus IF08631 were added to and mixed with the boiled soybean. After 20 hours' fermentation of the mixture as in Example 5, 50 g of the fermented product was placed in an airtight vessel with a net volume of 100 ml, and was subjected to an anaerobic treatment under an oxygen concentration of 1% or lower, thereby preparing a fermented soybean product. The contents of γ-aminobutyric acid and other free amino acids were measured according to the method in Example 5 using an amino acid autoanalyzer. As shown in Table 11, the content of γ-aminobutyric acid was 300 mg/100 g of dry product or more after the anaerobic treatment for 30 minutes or more, while the content of the free amino acid was 5% by dry weight or more after the anaerobic treatment of 5 hours or more.

TABLE 11
EFFECT OF ANAEROBIC TREATMENT TIME
CONDITION UNDER OF OXYGEN
CONCENTRATION OF 1% OR LOWER

| ANAEROBIC | γ-AMINOBUTYRIC | |
|---|---|---|
| TREATMENT TIME | ACID (mg/100 g | FREE AMINO ACID |
| (HR) | dry) | (% BY DRY WEIGHT) |
| 0.5 | 306 | 2.4 |
| 1.0 | 321 | 2.7 |
| 3.0 | 393 | 3.3 |
| 5.0 | 506 | 5.1 |

### EXAMPLE 12

Dehulled soybean (100 g) was soaked in 300 ml of 0.2% acetic acid for 12 hours, and was boiled at 120° C. for 5 minutes to prepare boiled soybean. Then, a suspension of spinhole of Rhizopus Oligosporus IF08631 were added to and mixed with the boiled soybean in a proportion of 1% by weight. The mixture was fermented for 20 hours with 20 hours' anaerobic treatment as in Example 5, thereby preparing a fermented soybean product. The fermented soybean product prepared was drum-dried, and the content of free amino acids as well as the contents of vitamins, minerals, antioxidant a super-oxide dismutase (SOD)-like activity, isoflavone and substances having an angiotensin (ACE) inhibition activity in the powder obtained were measured. As shown in Table 12, the fermented soybean product was rich in γ-aminobutyric acid while containing effective ingredients such as antioxidant, isoflavone, vitamins and minerals.

TABLE 12
EFFECTIVE INGREDIENTS IN FERMENTED SOYBAEN
PRODUCT BY Rhizopus oligosporus IF08631

| | | | |
|---|---|---|---|
| CONTENT OF FREE | 12.2 | VITAMIN GROUP | |
| AMINO ACID (% BY | | (mg/100 g DRY) | |
| DRY WEIGHT) | | | |
| CONTENT OF EACH | | VITAMIN B1 | 0.23 |
| FREE AMINO ACID | | | |
| (mg/100 g DRY) | | | |
| γ-AMINOBUTYRIC | 629 | VITAMIN B2 | 1.46 |
| ACID | | | |
| VALINE | 527 | VITAMIN B6 | 1.03 |
| ISOLEUCINE | 529 | INOSITOL | 417 |
| HISTIDINE | 396 | CHOLINE | 160 |
| LYSINE | 1026 | FOLIC ACID | 0.14 |
| PHENYLANANINE | 589 | | |
| THREONINE | 549 | MINERAL (mg/100 g | |
| | | DRY) | |
| ARGININE | 381 | POTTASIUM | 1010 |
| GLUTAMINE | 366 | MAGNESIUM | 176 |
| GLUTAMIC ACID | 1182 | PHOSPHOROUS | 539 |
| TYROSINE | 450 | IRON | 5.4 |
| ALANINE | 1568 | CALCIUM | 209 |
| | | ZINC | 3.9 |
| ISOFLAVONE | 153.8 | COPPER | 1.1 |
| (mg/100 g DRY) | | SOD INHIBITORY | 22 |
| | | ACTIVITY | |
| | | (INHIBITION RATIO %) | |
| | | ACE INHIBITORY | 40 |
| | | ACTIVITY (INHIBITION | |
| | | RATIO %) | |

### EXAMPLE 13

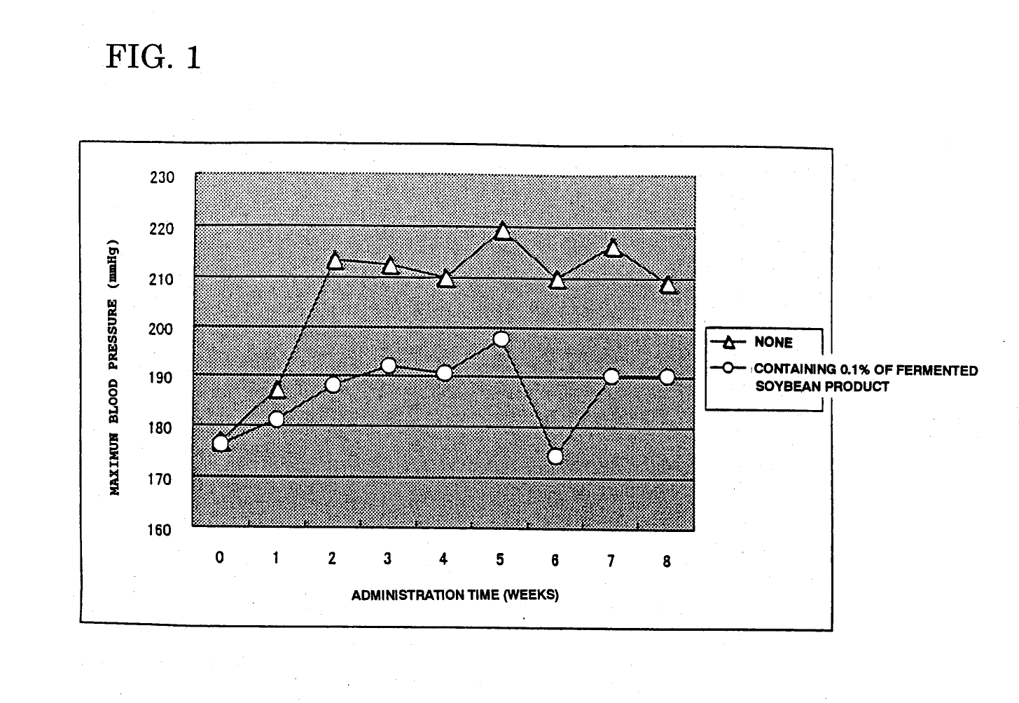

Dehulled soybean (100 g) was soaked in 300 ml of 0.2% acetic acid for 12 hours, and was boiled at 120° C. for 5 minutes to prepare boiled soybean. Then, a suspension of spinhole of Rhizopus Oligosporus IF032002 were added to and mixed with the boiled soybean in a proportion of 1% by weight. The mixture was fermented for 20 hours with 20 hours' anaerobic treatment as in Example 5, thereby preparing a fermented soybean product containing 1268 mg/100 g weight of γ-aminobutyric acid. The fermented soybean product prepared was drum-dried, and the powder obtained was added to a fodder in a proportion of 0.1% by weight as shown in Table 13. The fodder was fed to spontaneous hypertension rats (SHR) for elevation of systolic blood pressure tests. Six rats at age 11 weeks were allowed to freely feed on the fodder for 8 weeks with a measurement of the blood pressure once a week. As shown in FIG. 1, the rats in the group fed on the fodder supplemented with 0.1% by weight of the fermented soybean product showed a remarkable elevation of systolic blood pressure effect as compared with the rats fed on a fodder without any supplement of the fermented soybean product.

TABLE 13
COMPOSITION OF FODDER

| | | GORUP SUPPLEMENTED |
|---|---|---|
| | COMPARATIVE | WITH 0.1% FERMENTED |
| COMPONENTS (%) | GROUP | SOYBEAN PRODUCT |
| CASEIN (%) | 22.00 | 21.95 |
| LARD (%) | 10.00 | 9.97 |
| MIXTURE OF | 3.50 | 3.50 |
| MINERAL (%) | | |
| MIXTURE OF | 1.20 | 1.20 |
| VITAMINE (%) | | |
| CHOLINE | 0.15 | 0.15 |
| CHLORIDE (%) | | |
| CELLULOSE (%) | 3.00 | 3.00 |
| SODIUM CHLORIDE | 1.00 | 1.00 |
| (%) | | |
| SUCROSE (%) | 59.15 | 59.1 |
| FERMENTED | | 0.10 |
| SOYBEAN | | |
| PRODUCT (%) | | |

Examples corresponding to the third embodiment of the present invention will be described hereinafter with reference to Examples 14 and 15.

### EXAMPLE 14

Fermented cereal products rich in γ-aminobutyric acid and free amino acids were prepared using several cereals. Commercially available beans (azuki bean, black soybean, kidney bean, Kintoki kidney bean, Dainagon azuki bean) were soaked in 0.5% acetic acid solution for 15 hours. After drain, black soybean, kidney bean and Dainagon bean cut into a half size, and 20 g each of azuki bean and Kintoki kidney bean were placed in respective conical flasks with a net volume of 100 ml. Freeze dried green soybean, Ingen bean, common peas and corn were also used. Green soybean was cut into a half size while 20 g each of Ingen bean and common peas were cut into pieces with an width of 5 mm together with their sheaths, and they were placed in respective conical flask with a net volume of 100 ml. Ten grams each of while sesame seed, black sesame seed, peanut powder, wheat germ, wheat bran, soybean germ and rice bran were placed in respective conical flask with net a volume of 100 ml together with an equal volume of water. Each cereal in the 100 ml conical flask was sterilized by boiling at 121° C. for 10 minutes. A suspension of spinhole of Rhizopus oligosporus IF032002 was mixed with each boiled cereal in a proportion of 1% by weight, and the mixture was fermented for 20 hours under a condition of 37° C. and 90% relative humidity. After the cultivation, the fermented product was placed in an airtight vessel with a net volume of 100 ml, and was subjected to an anaerobic treatment at 37° C. for 20 hours after sufficiently purging the vessel with nitrogen. After the anaerobic treatment, the product was freeze-dried, the freeze-dried product was precisely weighed, and amino acids including γ-aminobutyric acid in the freeze-dried product was extracted with 8% trichloroacetic acid. The amino acids extracted were assayed using an amino acid autoanalyzer.

As shown in Table 14, each fermented cereal products contained 100 mg/100 g (dry weight) or more of γ-aminobutyric acid.

As shown in Table 15, each fermented cereal products contained 1000 mg/100 g (dry weight) or more of total free amino acids.

TABLE 14
CONTENT OF γ-AMINOBUTYRIC ACID (mg/100 g DRY
WEIGHT) IN EACH FERMENTED CEREAL PRODUCTS BY
Rhizopus oligosporus IF032002

| | 20 HOURS | 20 HOURS AFTER |
|---|---|---|
| | AFTER | ANAEROBIC |
| | FERMENTATION | FERMENTATION |
| GREEN SOYBEAN | 350 | 637 |
| GREEN PEAS | 174 | 424 |
| KIDNEY BEAN | 168 | 337 |
| COMMON PEAS | 547 | 588 |
| AZUKI BEAN | 43 | 128 |
| BLACK SOYBEAN | 252 | 573 |
| MOTTLED KIDNEY | 129 | 259 |
| BEANS | | |
| KINTOKI KIDNEY BEANS | 116 | 222 |
| DAINAGON AZUKI BEAN | 40 | 129 |
| WHITE SESAME SEED | 73 | 159 |
| BLACK SESAME SEED | 33 | 119 |
| CORN | 53 | 133 |
| PEANUT POWDER | 60 | 123 |
| WHEAT GERM | 140 | 242 |
| WHEAT BRAN | 133 | 436 |
| SOYBEAN GERM | 322 | 1353 |
| RICE BRAN | 63 | 240 |

TABLE 15
CONTENT OF TOTAL FREE AMINO ACIDS (mg/100 g DRY
WEIGHT) IN EACH FERMENTED CEREAL PRODUCTS
BY Rhizopus oligosporus IF032002

| | 20 HOURS | 20 HOURS AFTER |
|---|---|---|
| | AFTER | ANAEROBIC |
| | FERMENTATION | FERMENTATION |
| GREEN SOYBEAN | 1919 | 13355 |
| GREEN PEAS | 2405 | 11162 |
| KIDNEY BEAN | 1797 | 6651 |
| COMMON PEAS | 14097 | 16962 |
| AZUKI BEAN | 505 | 1954 |
| BLACK SOYBEAN | 1363 | 10217 |
| MOTTLED KIDNEY | 914 | 4291 |
| BEANS | | |
| KINTOKI KIDNEY BEAN | 1005 | 2963 |
| DAINAGON AZUKI BEAN | 470 | 2080 |
| WHITE SESAME SEED | 461 | 2697 |
| BLACK SESAME SEED | 359 | 2503 |
| CORN | 780 | 1750 |
| PEANUT POWDER | 780 | 5470 |
| WHEAT GERM | 1029 | 3264 |
| WHEAT BRAN | 835 | 6906 |
| SOYBEAN GERM | 3773 | 19290 |
| RICE BRAN | 558 | 3229 |

### EXAMPLE 15

A fermented cereal product rich in γ-aminobutyric acid and free amino acids was prepared using corn. Twenty grams of commercially available freeze-dried corn was placed in a conical flask with a net volume of 100 ml, and was sterilized by boiling at 121° C. for 10 minutes. A powder of commercially available rice Koji mold (Aspergillus oryzae) was added to the boiled cereal in a proportion of 1% by weight, and the mixture was cultivated for 48 hours under the condition of 37° C. and 90% relative humidity. After the cultivation, the fermented product was placed on a 100 ml airtight vessel with sufficient purging of nitrogen, and was subjected to an anaerobic treatment at 37° C. for 20 hours. After the anaerobic treatment, the product was freeze-dried, the freeze-dry product obtained was precisely weighed, and amino acids including γ-aminobutyric acid was extracted with 8% trichloroacetic acid. The content of each amino acid extracted was assayed using an amino acid autoanalyzer.

As shown in Table 16, the fermented cereal product obtained contains 100 mg/100 g dry weight or more of γ-aminobutyric acid.

Table 16 also shows that the fermented cereal product obtained contains 1000 mg/100 g dry weight or more of total free amino acids.

TABLE 16
CONTENTS OF γ-AMINOBUTYRIC ACID AND TOTAL FREE
AMINO ACIDS (mg/100 g DRY WEIGHT) IN FERMENTED
CORN BY Aspergillus oryzae

| | 48 HOURS | 20 HOURS AFTER |
|---|---|---|
| | AFTER | ANAEROBIC |
| | FERMENTATION | FERMENTATION |
| γ-AMINOBUTYRIC ACID | 17 | 116 |
| TOTAL FREE AMINO | 359 | 1883 |
| ACIDS | | |

Industrial Applicability

The first embodiment of the present invention provides fermented soybean foods rich in γ-aminobutyric acid while containing effective ingredients such as proteins, amino acids and antioxidant originating from soybean and fermented soybean products by fermentation by Tempe molds belonging to genus Rhizopus using only soybean as a natural food material. These products may be used as foodstuffs having an excellent quality with a reasonable price.

The second embodiment of the present invention provides fermented soybean foods rich in γ-aminobutyric acid having various physiological functions and tasting free amino acids by fermentation of soybean with an anaerobic treatment by Tempe molds belonging to genus Rhizopus using only soybean as a natural food material. The fermented soybean foods also contain effective ingredients such as proteins, peptides, antioxidant, vitamins, minerals and isoflavone generating from soybean and fermented soybean products while having a elevation of systolic blood pressure effect. These products may be used as foodstuffs having an excellent quality with a reasonable price.

The third embodiment of the present invention provides fermented cereal foods rich in γ-aminobutyric acid having various physiological functions and tasting free amino acids by fermentation of cereals with an anaerobic treatment by Koji molds using only cereals as a natural food material. The fermented cereal products also contain effective ingredients such as vitamins, anthocyanin, sesamin, isoflavone, soybean saponin, phytic acid, dietary fibers, minerals and antioxidant originating from the cereals, and effective ingredients such as digested proteins, peptides and antioxidant originating from the fermented cereal products. These products may be used as foodstuffs having an excellent quality with a reasonable price.

1. A process for producing fermented soybean foods rich in γ-aminobutyric acid by fermentation of soybean using Tempe molds.

2. The process for producing fermented soybean foods rich in γ-aminobutyric acid according to claim 1, wherein the Tempe mold belongs to genus Rhizopus.

3. The process for producing fermented soybean foods rich in γ-aminobutyric acid according to claim 2, wherein the genus Rhizopus is Rhizopus oligosporus or Rhizopus oryzae.

4. A process for producing fermented soybean foods rich in γ-aminobutyric acid while containing effective ingredients originating from soybean and fermented soybean products such as proteins, amino acids and antioxidant.

5. A process for producing fermented soybean foods rich in γ-aminobutyric acid and free amino acids produced by fermentation of soybean using Tempe molds belonging to genus Rhizopus with an anaerobic treatment.

6. The process for producing fermented soybean foods rich in γ-aminobutyric acid and free amino acids according to claim 5, wherein the mold belonging to genus Rhizopus is Rhizopus oligosporus or Rhizopus oryzae.

7. The process for producing fermented soybean foods rich in γ-aminobutyric acid and free amino acids according to claim 5, wherein the quantity (g) of the fermented soybean products per unit volume of an airtight vessel is 0.005 to 1.0 g/cm³.

8. The process for producing fermented soybean foods rich in γ-aminobutyric acid and free amino acids according to claim 5, wherein the anaerobic treatment time is 30 minutes or more for enriching γ-aminobutyric acid and 5 hours or more for enriching the free amino acids after the oxygen concentration has been reduced to 1% or lower.

9. The process for producing fermented soybean foods rich in γ-aminobutyric acid and free amino acids according to claim 5, wherein the content of γ-aminobutyric acid is 0.3% by dry weight or more of the fermented soybean product, and the content of the free amino acids is 5% by dry weight or more of the fermented soybean product.

10. The process for producing fermented soybean foods rich in γ-aminobutyric acid and free amino acids according to claim 5 also containing effective ingredients originating from soybean and fermented soybean products such as proteins peptides, vitamins, antioxidant, minerals, isoflavone and angiotensin conversion enzyme inhibitors.

11. The fermented soybean food obtained by the process for producing fermented soybean foods rich in γ-aminobutyric acid and free amino acids according to claims 5 to 10.

12. The fermented soybean food according to claim 11 having a elevation of systolic blood pressure effect.

13. The fermented soybean food according to claim 11 having a food function enrichment effect.

14. A process for producing fermented cereal foods rich in γ-aminobutyric acid and free amino acids by fermentation of cereals using Koji molds.

15. A process for producing fermented cereal foods rich in γ-aminobutyric acid and free amino acids by fermentation of cereals using Koji molds with an anaerobic treatment.

16. The process for producing fermented cereal foods rich in γ-aminobutyric acid and free amino acids according to claims 14 and 15, wherein the Koji mold belongs to genus Rhizopus.

17. The process for producing fermented cereal foods rich in γ-aminobutyric acid and free amino acids according to claims 14 and 15, wherein the mold belonging to genus Rhizopus is Rhizopus oligosporus or Rhizopus oryzae.

18. The process for producing fermented cereal foods rich in γ-aminobutyric acid and free amino acids according to claims 14 and 15, wherein the Koji mold belongs to genus Aspergillus.

19. The process for producing fermented cereal foods rich in γ-aminobutyric acid and free amino acids according to claims 14 and 15, wherein the mold belonging to genus Aspergillus is Aspergillus oligosporus or Aspergillus niger.

20. The process for producing fermented cereal foods rich in γ-aminobutyric acid and free amino acids according to claims 14 and 15, wherein the total content of γ-aminobutyric acid and free amino acids accounts for 1% by dry weight or more of the fermented cereal products.

21. The process for producing fermented cereal foods rich in γ-aminobutyric acid and free amino acids according to claims 14 and 15, wherein the cereals used for the fermented cereal foods rich in γ-aminobutyric acid and free amino acids include beans, seeds, wheat and barley, and miscellaneous cereals.

22. The process for producing fermented cereal foods rich in γ-aminobutyric acid and free amino acids according to claims 14 and 15, wherein bran as refining residues of cereals, isolated germ or total grains of cereals including these residues are used for the fermented cereal foods rich in γ-aminobutyric acid and free amino acids.
